(19) United States
(12) Patent Application Publication
(10) Pub. No.: US 2018/0043763 A1
(43) Pub. Date: Feb. 15, 2018

(54) BATTERY MOUNTING FRAME

(71) Applicant: TOYODA IRON WORKS CO., LTD., Toyota-shi, Aichi (JP)

(72) Inventor: Michio SUZUMORI, Toyota-shi (JP)

(73) Assignee: TOYODA IRON WORKS CO., LTD., Toyota-shi, Aichi (JP)

(21) Appl. No.: 15/551,577

(22) PCT Filed: Oct. 14, 2015
(86) PCT No.: PCT/JP2015/079017

§ 371 Date: Aug. 16, 2017

(30) Foreign Application Priority Data
Feb. 18, 2015 (JP) 2015-029466

(51) Int. Cl. B60K 1/04

(52) U.S. Cl. CPC B60K 1/04; B60K 2001/0438

(57) ABSTRACT

A battery mounting frame for mounting a battery on a vehicle, including a hollow frame having a pair of first frame members, positioned in the vehicle on front and rear sides of the battery, extending in a lateral direction of the vehicle, and a pair of second frame members positioned in the vehicle on laterally outward sides of the battery, the second frame members connecting ends of the first, wherein the battery mounting frame is supported by a vehicle body so the battery is located inside the frame. Each first frame member has a length equal to or larger than that of the second frame member, and each first frame member has, in each lateral end portion, a first bend of a first angle so the first frame member is positioned more toward the outside of the frame as it goes from the first bend laterally outward in the vehicle.

### TECHNICAL FIELD

The present invention relates to battery mounting frames that are used for a battery to be mounted on vehicles.

### BACKGROUND ART

In recent years, hybrid vehicles equipped with a battery have been increasingly produced to improve the fuel economy of gasoline vehicles for environmental friendliness, as well as electric vehicles have been actively developed. Electric and hybrid vehicles are propelled by a motor using a battery as a power supply for propulsion. As is well known in the art, the battery in an electric or hybrid vehicle accounts for a larger proportion of the overall volume and weight of the vehicle body than that in a conventional automobile that is propelled by an engine using gasoline or diesel oil as fuel.

Various inventions have been made for mounting a battery that supplies power for propulsion on electric vehicles and hybrid vehicles. The invention described in Patent Document 1 is an example known in the art. In the invention described in Patent Document 1, a battery that supplies power for propulsion is placed inside a watertight on-board battery tray, and the bottom of the on-board battery is supported by an outer frame serving as a battery frame, which is secured to the vehicle body structure. The outer frame comprises four frame members, which are hollow aluminum alloy extrusions, with their ends joined via L-shaped corner members made of aluminum alloy.

### RELATED ART DOCUMENTS

### Patent Documents

Patent Document 1: Japanese Patent Application Publication No. 2013-133044

### SUMMARY OF THE INVENTION

### Problem to be Solved by the Invention

In the invention described in Patent Document 1, however, the frame members and the corner members are formed by pressing a sheet of aluminum alloy. The support structure for the on-board battery is thus complicated, leading to an increase in cost for molds and welding. Aluminum alloys are light in weight but high in unit price. Accordingly, the invention described in Patent Document 1 would require higher cost for the support structure for the on-board battery.

When a battery is mounted on the vehicle as a power supply for propulsion, the battery needs to be protected from an impact load applied in the event of a collision of the vehicle. In particular, vehicle regulations require sufficient consideration for protection of the batteries from an impact load that is applied in the event of a side collision of the vehicle. Accordingly, when a battery mounting frame is used to mount a driving battery on a vehicle, it is necessary to reduce the deformation of the battery mounting frame in the lateral directions in the vehicle caused by an impact load in the event of a side collision.

The battery mounting frame is deformed under an impact load in various amounts and directions according to the magnitude and direction of the impact load. In the case of a side collision, the battery mounting frame tends to be expanded in the longitudinal direction of the vehicle under the impact load. Electrical components or other surrounding components are disposed around the on-board battery. Accordingly, when deformed by an impact load the battery mounting frame may contact the surrounding components to cause failure of the surrounding components.

The present invention relates to battery mounting frames used for mounting a battery on a vehicle, and provides a battery mounting frame that can protect the battery from an impact load applied in the event of a side collision while preventing the battery from damaging surrounding components.

### Means for Solving the Problem

One aspect of the present invention provides a battery mounting frame for mounting a battery on a vehicle, comprising a hollow frame having a pair of first frame members positioned in the vehicle on front and rear sides of the battery mounted on the vehicle, the first frame members extending in a lateral direction of the vehicle, and a pair of second frame members positioned in the vehicle on laterally outward sides of the battery, the second frame members connecting ends of the first frame members, wherein the battery mounting frame is supported by a vehicle body such that the battery is located inside the frame. The battery mounting frame is characterized in that each first frame member has a length equal to or larger than that of the second frame member, and each first frame member has, in each lateral end portion, a first bend of a first angle such that the first frame member is positioned more toward the outside of the frame as it goes from the first bend laterally outward in the vehicle.

The battery mounting frame thus configured comprises a hollow frame having the pair of first frame members and the pair of second frame members and is supported by the vehicle body such that the battery is located inside the frame. The battery mounting frame thus bears the impact load in the event of a side collision of the vehicle, thereby protecting the battery placed inside the battery mounting frame. In the battery mounting frame, the first frame members are positioned in the vehicle on the front and rear sides of the battery. The first frame member has a length equal to or larger than that of the second frame member and extends in the lateral direction of the vehicle. Each lateral end portion of the frame member has the first bend of a first angle such that the lateral end portion is positioned more toward the outside of the frame as it goes from the first bend laterally outward in the vehicle. With these first bends in the first frame members, the battery mounting frame reduces the amount by which a laterally middle section of the first frame member is deformed toward the outside of the frame (i.e. toward the vehicle front or rear) when an impact load is applied in the event of a side collision. The battery mounting frame thus reduces contact of the battery and the battery mounting frame with surrounding components, thereby preventing damage to the surrounding components. The battery mounting frame achieves protection of the battery from side collisions and prevention of damage to the surrounding components by merely including the first bends in each of the first frame members, which can be preferably implemented without substantial cost increase.

Another aspect of the present invention provides a battery mounting frame according to claim 1, characterized in that the first frame member has a second bend of a second angle at a location that is laterally outward in the vehicle relative to each first bend, and each second bend is such that the first frame member is positioned more toward the inside of the frame, with respect to a direction in which the first frame member extends between the first and second bends, as it goes from the second bend laterally outward in the vehicle.

In the battery mounting frame thus configured, the first frame member has the second bend in each lateral end portion at a location that is laterally outward in the vehicle relative to the first bend. Accordingly, each lateral end portion of the first frame member turns through the first bend forming a first angle to be positioned more toward the outside of the frame as it goes from the first bend laterally outward in the vehicle, and further turns through the second bend forming a second angle to be positioned more toward the inside of the frame with respect to the direction in which the first frame member extends between the first and second bends, as it goes from the second bend laterally outward in the vehicle. With these first and second bends in the first frame members, the battery mounting frame further reduces the deformation of the laterally middle section of each first frame member toward the outside of the frame (i.e. toward the vehicle front or rear) caused by an impact load in the event of a side collision. The battery mounting frame thus reduces contact of the battery and the battery mounting frame with surrounding components, thereby preventing damage to the surrounding components. The inclusion of the first and second bends in the first frame members for reducing deformation of the first frame member under an impact load has less influence on the size of space required for placing the battery mounting frame. Moreover, the battery mounting frame can more effectively achieve protection of the battery from a side collision and prevention of damage to the surrounding components by merely including the first and second bends in each first frame member, which can be implemented without substantial cost increase.

Still another aspect of the present invention provides a battery mounting frame according to claim 1 or 2, characterized in that the first frame members and the second frame members each comprise a steel tube, and the battery mounting frame is formed by joining the ends of the first frame members and ends of the second frame members.

In the battery mounting frame thus configured, the first frame members and the second frame members each comprise a steel tube, and the battery mounting frame is formed by joining the ends of the first frame members and the ends of the second frame members, which allows for simple and inexpensive production of a battery mounting frame that can protect the battery from a side collision while preventing damage to surrounding components.

### Effects of the Invention

A battery mounting frame thus configured comprises the hollow frame having the pair of first frame members and the pair of second frame members, and is supported by the vehicle body such that the battery is located inside the frame. Each lateral end portion of the first frame member has the first bend of a first angle such that the lateral end portion is positioned more toward the outside of the frame as it goes from the first bend laterally outward in the vehicle. The first bends in the first frame member can protect the battery from an impact load and reduce the deformation of the first frame member toward the outside of the frame (i.e. toward the vehicle front or rear) caused by the impact load in the event of a side collision.

### BRIEF DESCRIPTION OF THE DRAWINGS

FIG. 1 is a perspective view of appearance of a battery mounting frame according to a First Embodiment.

FIG. 2 is a plan view of the battery mounting frame according to the First Embodiment.

FIG. 3 is a plan view showing details of first bends according to the First Embodiment.

FIG. 4 is an illustration of the battery mounting frame according to the First Embodiment and a conventional example.

FIG. 5 is an illustration of comparison of the battery mounting frame according to the First Embodiment and the conventional example with respect to the amount of deformation in the event of a side collision.

FIG. 6 is a perspective view of appearance of a battery mounting frame according to a Second Embodiment.

FIG. 7 is a plan view of the battery mounting frame according to the Second Embodiment.

FIG. 8 is a plan view showing details of first bends and second bends according to the Second Embodiment.

FIG. 9 is an illustration of the battery mounting frame according to the Second Embodiment, the conventional example, and the First Embodiment.

FIG. 10 is an illustration of comparison of the battery mounting frame according to the Second Embodiment, the conventional example, and the First Embodiment with respect to the amount of deformation in the event of a side collision.

### MODES FOR CARRYING OUT THE INVENTION

Embodiments including a battery mounting frame 1 for mounting a battery on a vehicle which embodies the battery mounting frame of the present invention will be described in detail below with reference to the accompanying drawings.

### General Configuration of Battery Mounting Frame of First Embodiment

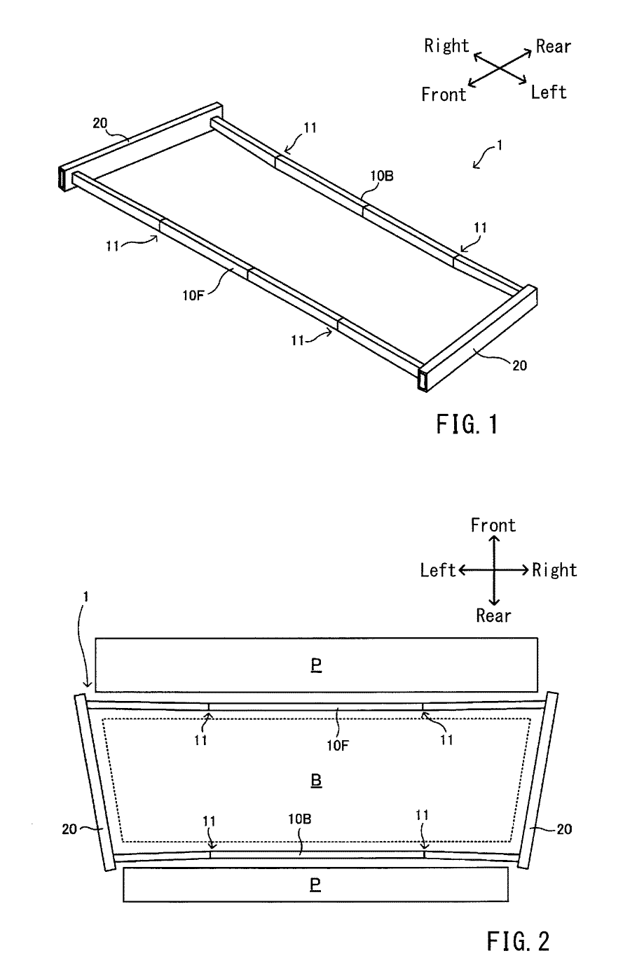

First, the general configuration of the battery mounting frame 1 in a First Embodiment will be described in detail with reference to FIGS. 1 to 3. The battery mounting frame 1 comprises a hollow frame including a front frame member 10F, a back frame member 10B, and a pair of side frame members 20, and is disposed in a vehicle that propels with an electric motor serving as a drive source (e.g., a hybrid or electric vehicle).

The vehicle includes a battery B disposed under a rear seat. The battery B stores electric power to be supplied to the electric motor that serves as a drive source of the vehicle. The battery mounting frame 1 is disposed below the rear seat of the vehicle so as to enclose the battery B as viewed in plan (see FIGS. 1 and 2).

Surrounding components P are disposed around the battery B under the rear seat of the vehicle. The surrounding components P may include, for example, an electrical component that supplies electric power from the battery B to the electric motor. The battery mounting frame 1, which comprises a hollow frame including the front frame member 10F, the back frame member 10B, and the two side frame members 20 as described above, may be trapezoidal as viewed in plan due to the geometry of the vehicle and the arrangement of the surrounding components P.

As shown in FIGS. 1 to 3, the front frame member 10F is one of the frame members that form the battery mounting frame 1, and is positioned on the vehicle front side of the battery B. The front frame member 10F comprises a rectangular steel tube having a rectangular cross section, and is an example of the first frame member of the present invention. As shown in FIG. 2, the front frame member 10F is longer than the back frame member 10B and the side frame members 20, and has a first bend 11 in each longitudinal end portion. The first bends 11 will be described in detail later. The term longitudinal end portion, as used herein, may refer to that section of either first frame member (i.e. the front frame member 10F or the back frame member 10B) which extends from about ⅓ of the whole length laterally outward in the vehicle.

The back frame member 10B is one of the frame members that form the battery mounting frame 1, and is positioned on the vehicle rear side of the battery B. Like the front frame member 10F, the back frame member 10B comprises a rectangular steel tube having a rectangular cross section, and is an example of the first frame member of the present invention. The back frame member 10B is longer than the side frame members 20 and is slightly shorter than the front frame member 10F. Like the front frame member 10F, the back frame member 10B has a first bend 11 in each longitudinal end portion.

The side frame members 20 are two of the frame members that form the battery mounting frame 1, and are positioned on the vehicle left/right sides of the battery B (i.e. on the laterally outward sides of the battery B). Each side frame member 20 comprises a rectangular steel tube having a rectangular cross section and connects the ends of the front and back frame members 10F and 10B. Each side frame member 20 comprises a rectangular steel tube having a rectangular cross section and is shorter than the front and back frame members 10F and 10B.

In the battery mounting frame 1, the front frame member 10F is welded to the side frame members 20 with its end faces butted with side surfaces (ones inside the hollow frame) of the side frame members 20. Similarly, the back frame member 10B is welded to the side frame members 20 with its end faces butted with side surfaces (ones inside the hollow frame) of the side frame members 20. Each side frame member 20 thus connects the ends of the front and back frame members 10F and 10B. In this way the battery mounting frame 1 is formed to comprise a hollow frame having a trapezoidal shape as viewed in plan and enclosing the battery B.

In the battery mounting frame 1 in First Embodiment, each of the front and back frame members 10F and 10B has the first bends 11 in the lateral end portions. The first bends 11 in each of the front and back frame members 10F and 10B are located at about ¼ of the whole length from the ends of the front frame member 10F or the back frame member 10B.

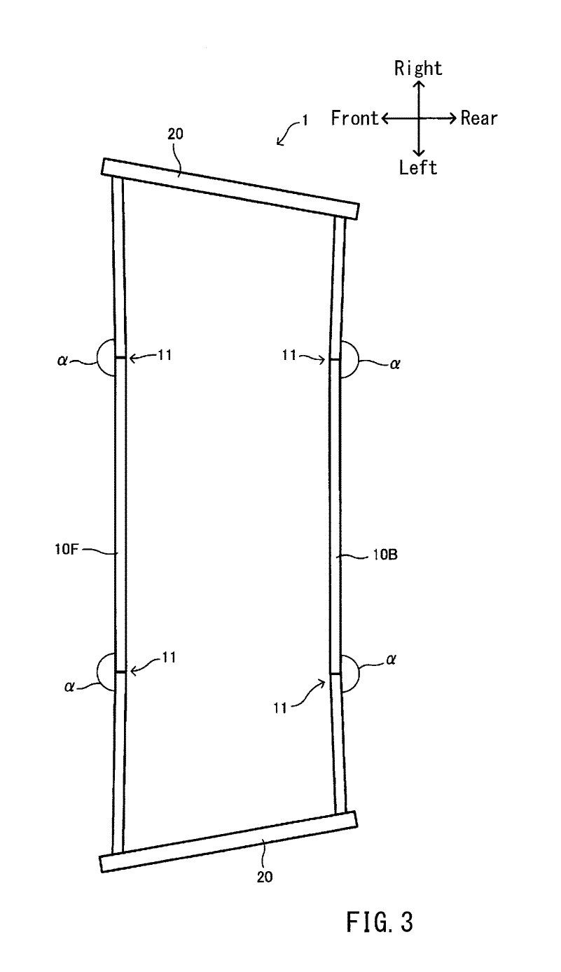

Each first bend 11 in the front frame member 10F is formed by displacing an outward section of the front frame member 10F, located laterally outward in the vehicle relative to the first bend 11, toward the vehicle front with respect to the laterally middle section of the front frame member 10F, so that the first bend 11 has a first angle α. The first angle α is the angle (e.g., 175° to 179°) formed by the laterally middle section of the front frame member 10F and the outward section of the front frame member 10F located laterally outward in the vehicle relative to the first bend 11. Each end section of the front frame member 10F is thus positioned more toward the outside of the frame (i.e. toward the vehicle front) as it goes from the first bend 11 laterally outward in the vehicle (see FIG. 3).

Each first bend 11 in the back frame member 10B is formed by displacing an outward section of the back frame member 10B, located laterally outward in the vehicle relative to the first bend 11, toward the vehicle rear with respect to the laterally middle section of the back frame member 10B, so that the first bend 11 has a first angle α. The first angle α is the angle (e.g., 175° to 179°) formed by the laterally middle section of the back frame member 10B and the outward section of the back frame member 10B located laterally outward in the vehicle relative to the first bend 11. As shown in FIG. 3, each end section of the back frame member 10B is thus positioned more toward the outside of the frame (toward the vehicle rear) as it goes from the first bend 11 laterally outward in the vehicle.

The first angle α of the first bends 11 in the front and back frame members 10F and 10B may be determined according to the displacement of the side frame member 20 under an impact load F in the event of a side collision of the vehicle. The first angle α in the front frame member 10F may be the same as or different from the first angle α in the back frame member 10B.

The battery mounting frame 1 in First Embodiment configured as described above comprises a hollow frame with the front frame member 10F, the back frame member 10B, and the two side frame members 20 and is disposed so as to enclose the battery B. Accordingly, when subjected to an impact load F in the event of a side collision of the vehicle, the battery mounting frame 1 in First Embodiment is deformed under the impact load F, thereby protecting the battery B placed inside the battery mounting frame 1.

### Comparison Between Battery Mounting Frame of First Embodiment and Conventional Example

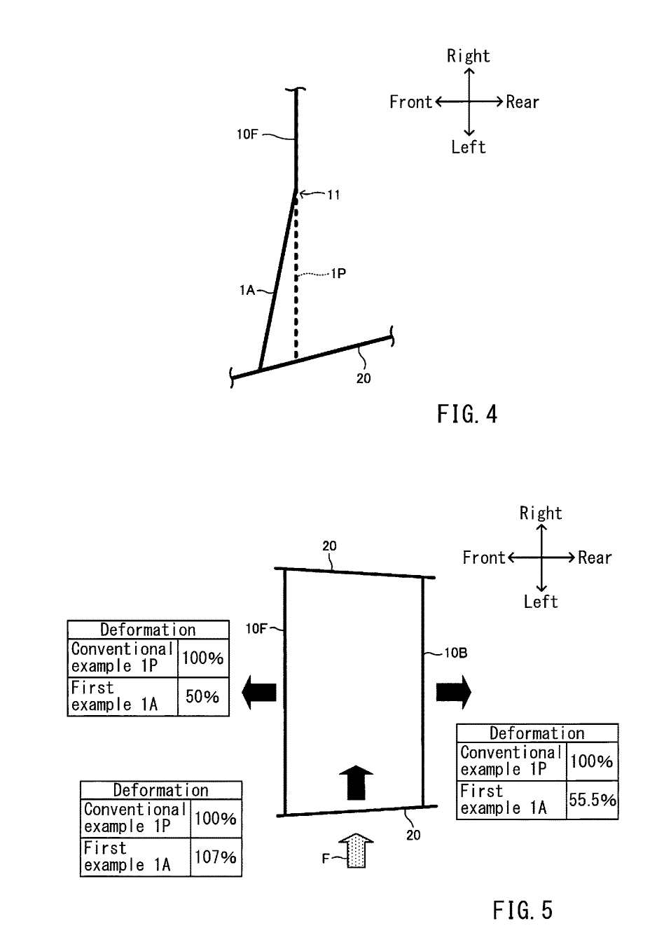

The battery mounting frame 1 in First Embodiment will be compared with a conventional example with reference to FIGS. 4 and 5 with regard to the amount of deformation that is caused by an impact load in the event of a side collision of the vehicle. In the following description, First Example 1A is a battery mounting frame 1 in the First Embodiment, and Conventional Example 1P is a conventional battery mounting frame.

First, the configuration of a battery mounting frame corresponding to Conventional Example 1P will be described. Like the battery mounting frame 1 in First Embodiment, the battery mounting frame of Conventional Example 1P comprises a hollow frame having a trapezoidal shape as viewed in plan including a front frame member 10F, a back frame member 10B, and a pair of side frame members 20, each comprising a rectangular steel tube.

The difference between First Example 1A (the battery mounting frame 1 in First Embodiment) and Conventional Example 1P is whether the front and back frame members 10F and 10B have the first bends 11 or not. That is, the front and back frame members 10F and 10B of Conventional Example 1P do not have the first bends 11 and are formed by a rectangular steel tube extending linearly.

In Conventional Example 1P, the front and back frame members 10F and 10B are disposed in the same positions as the laterally middle sections of the front and back frame members 10F and 10B in First Example 1A. Since the front and back frame members 10F and 10B of Conventional Example 1P extend linearly, the positions at which the ends of the front and back frame members 10F and 10B are joined to the side surface of each side frame member 20 in Conventional Example 1P are located more inward of the frame than the positions at which the front and back frame members 10F and 10B are joined to each side frame member 20 in First Example 1A described above (see FIG. 4).

How each frame member is deformed when the battery mounting frames 1 (Conventional Example 1P and First Example 1A) configured as described above are subjected to an impact load F in the event of a side collision of the vehicle will be described below. In the following description, it is assumed that an impact load F is applied from the left side of the vehicle due to a side collision on the left side of the vehicle.

In the case where an impact load F is applied from the left side of the vehicle, the side frame member 20 on the left side of the vehicle is bent due to the impact load F and is displaced toward the inside of the frame, that is, the battery mounting frame 1. Since the side frame member 20 on the left side of the vehicle is displaced toward the inside of the frame, the front frame member 10F of the battery mounting frame 1 is compressed between the side frame members 20 on both sides by the impact loads F. The front frame member 10F of the battery mounting frame 1 is thus deformed by the impact load F, so that the laterally middle section of the front frame member 10F is displaced toward the vehicle front.

Similarly, since the side frame member 20 on the left side of the vehicle is displaced toward the inside of the frame, the back frame member 10B of the battery mounting frame 1 is compressed between the side frame members 20 on both sides by the impact loads F. The back frame member 10B of the battery mounting frame 1 is thus deformed by the impact load F, so that the laterally middle section of the back frame member 10B is displaced toward the vehicle rear.

Next, comparison between Conventional Example 1P and First Example 1A (First Embodiment) will be described with reference to FIG. 5 with regard to the amount by which each frame member is deformed when subjected to an impact load F of a certain magnitude by a side collision on the left side of the vehicle. In the following description, the amount of deformation of each frame member in Conventional Example 1P is defined as 100% in the comparison with the amount of deformation of each frame member in First Example 1A.

As shown in FIG. 5, in the case where an impact load F of a certain magnitude is applied from the left side of the vehicle to the battery mounting frame 1 of First Example 1A, the amount of deformation of the side frame member 20 in First Example 1A is 107% relative to Conventional Example 1P that is 100%. This means a 7% increase relative to Conventional Example 1P. If the increase in amount of deformation of the side frame member 20 in First Example 1A is as small as about 7%, then the side frame member 20 will not contact the battery B placed inside the battery mounting frame 1, so that the battery B is protected by the battery mounting frame 1.

In the case where the impact load F of the certain magnitude is applied from the left side of the vehicle to the battery mounting frame 1, the amount of deformation of the front frame member 10F in First Example 1A is 50% relative to Conventional Example 1P that is 100%. This means a 50% decrease relative to Conventional Example 1P. The amount of deformation of the front frame member 10F is thus decreased to 50% in First Example 1A. The battery mounting frame 1 of First Example 1A (First Embodiment) thus reduces the possibility that the front frame member 10F may be deformed toward the vehicle front so much as to contact any of the surrounding components P in the event of a side collision, and thereby prevents damage to the surrounding components P.

In the case where the impact load F of the certain magnitude is applied from the left side of the vehicle, the amount of deformation of the back frame member 10B in First Example 1A is about 55.5% relative to Conventional Example 1P that is 100%. This means about a 44.5% decrease relative to Conventional Example 1P. The amount of deformation of the back frame member 10B is thus decreased to about 55.5% in First Example 1A. Therefore, the battery mounting frame 1 of First Example 1A (First Embodiment) reduces the possibility that the back frame member 10B may be deformed toward the vehicle rear so much as to contact any of the surrounding components P in the event of a side collision, thereby preventing damage to the surrounding components P.

As described above, the battery mounting frame 1 in First Embodiment comprises a hollow frame having the front frame member 10F, the back frame member 10B, and the two side frame members 20 and having a trapezoidal shape as viewed in plan, and is disposed such that the battery B is located inside the frame (see FIG. 2). As shown in FIG. 5, the battery mounting frame 1 can thus bear the impact load F in the event of a side collision of the vehicle, thereby protecting the battery B placed inside the frame from the impact load F.

In the battery mounting frame 1 in First Embodiment, the front frame member 10F has the first bends 11, and the lateral end portions of the front frame member 10F are bent at the first angle α at the first bends 11. Each lateral end portion of the front frame member 10F is thus positioned more toward the vehicle front as it goes from the first bend laterally outward in the vehicle. The back frame member 10B also has the first bends 11, and the lateral end portions of the back frame member 10B are bent at the first angle α at the first bends 11. Each lateral end portion of the back frame member 10B is thus positioned more toward the vehicle rear as it goes from the first bend laterally outward in the vehicle.

As shown in FIG. 5, the battery mounting frame 1 in First Embodiment includes the first bends 11 in the lateral end portions of the front and back frame members 10F and 10B. This can reduce the amounts by which the front and back frame members 10F and 10B are deformed when subjected to an impact load F in the event of a side collision of the vehicle to about 50% of Conventional Example 1P. The battery mounting frame 1 thus reduces contact of the battery mounting frame 1 with the battery B and the surrounding components P, thereby preventing damage to the surrounding components P. The battery mounting frame 1 has an improved capability of preventing damage to the surrounding components P by merely including the first bends 11 in the front and back frame members 10F and 10B. This allows for producing a high performance battery mounting frame 1 without substantial cost increase.

As shown in FIG. 1, in First Embodiment, the front frame member 10F, the back frame member 10B, and the two side frame members 20 are each formed by a rectangular steel tube, and the battery mounting frame 1 is formed by welding the front and back frame members 10F and 10B to each side frame member 20 with the end faces of the front and back frame members 10F and 10B butted with the side surface of the side frame member 20. This configuration allows for inexpensively producing a simply configured battery mounting frame 1 that can protect the battery B from a side collision while preventing damage to the surrounding components P.

### Second Embodiment

An embodiment different from First Embodiment above (Second Embodiment) will be described in detail with reference to the drawings, which more effectively reduces the deformation of the front and back frame members 10F and 10B in the event of a side collision.

### General Configuration of Battery Mounting Frame of Second Embodiment

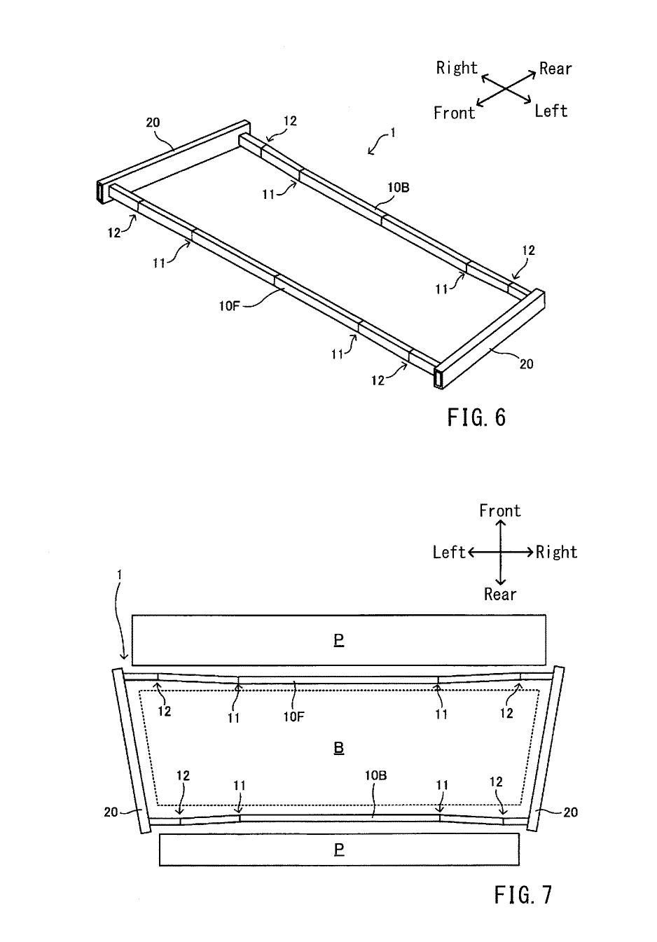

The general configuration of the battery mounting frame 1 in Second Embodiment will be described in detail with reference to FIGS. 6 to 8. The battery mounting frame 1 in Second Embodiment has a basic configuration similar to that of the battery mounting frame 1 in First Embodiment except for the configurations of the front and back frame members 10F and 10B. Accordingly, in the following description, description of the configurations similar to those of First Embodiment is omitted, and configurations different from those of First Embodiment will be described in detail.

As shown in FIGS. 6 to 8, the battery mounting frame 1 in the Second Embodiment, as in First Embodiment, comprises a hollow frame with a front frame member 10F, a back frame member 10B, and a pair of side frame members 20, and is disposed in a vehicle that propels with an electric motor (motor) serving as a drive source (e.g., a hybrid or electric vehicle). In the battery mounting frame 1 in Second Embodiment, the two side frame members 20 each comprise a rectangular steel tube having a rectangular cross section in a manner similar to that of the side frame members 20 in First Embodiment.

As in First Embodiment, the front frame member 10F in Second Embodiment comprises a rectangular steel tube having a rectangular cross section and is positioned on the vehicle front side of the battery B. The front frame member 10F in Second Embodiment has first bends 11 bent at a first angle α at locations similar to those of First Embodiment. As in First Embodiment, the first angle α in the front frame member 10F in Second Embodiment may be determined according to the amount by which the side frame member 20 is displaced when subjected to an impact load F in the event of a side collision of the vehicle. For example, the first angle α may range from 175° to 179°.

Unlike First Embodiment, the front frame member 10F in the Second Embodiment has second bends 12 located laterally outward in the vehicle relative to the first bends 11. In the front frame member 10F in Second Embodiment, the second bends 12 are located at about 1/12 of the whole length from the ends of the front frame member 10F.

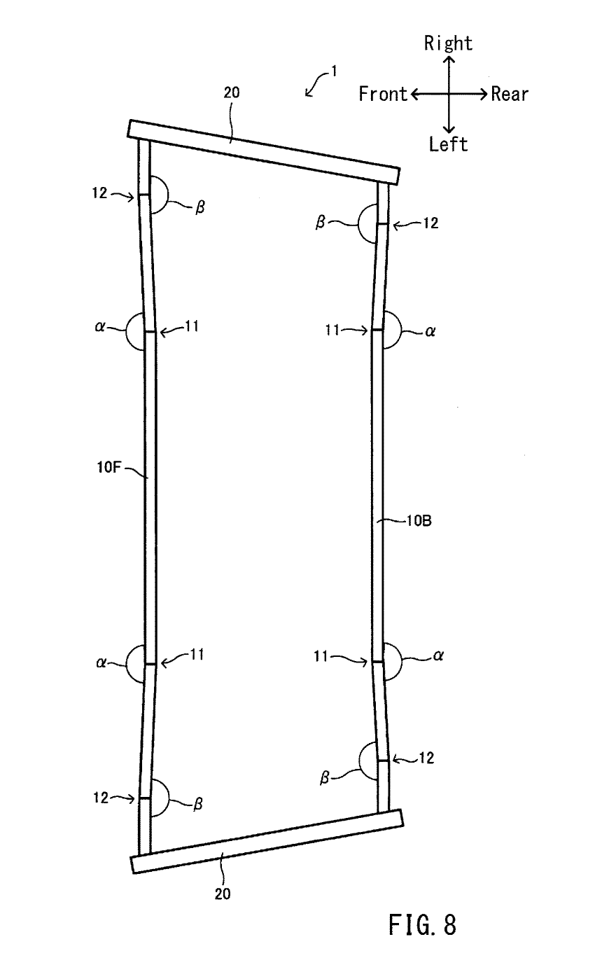

In the front frame member 10F in Second Embodiment, each second bend 12 is formed by displacing an outward section of the front frame member 10F, located laterally outward in the vehicle relative to the second bend 12, toward the vehicle rear at a second angle β with respect to an intermediate section extending between the first and second bends 11 and 12 in the front frame member 10F. The second angle β is the angle formed by the intermediate section extending between the first and second bends 11 and 12 and the outward section located laterally outward in the vehicle relative to the second bend 12. The second angle β may be about the same as the first angle α at the first bend 11 (e.g., 175° to 179°) and preferably the same as the first angle α. Each end section of the front frame member 10F is thus positioned more toward the inside of the frame (i.e. toward the vehicle rear) with respect to the direction in which the front frame member 10F extends between the first and second bends 11 and 12, as it goes from the second bend laterally outward in the vehicle from the second bend 12 (see FIG. 8).

The back frame member 10B in the Second Embodiment comprises a rectangular steel tube having a rectangular cross section and is positioned on the vehicle rear side of the battery B. The back frame member 10B in Second Embodiment has first bends 11 bent at a first angle α at locations similar to those of First Embodiment. As in First Embodiment, the first angle α in the back frame member 10B in Second Embodiment may be determined according to the amount by which the side frame member 20 is displaced when subjected to an impact load F in the event of a side collision of the vehicle. For example, the first angle α may range from 175° to 179°.

Like the front frame member 10F, the back frame member 10B in the Second Embodiment has second bends 12 located laterally outward in the vehicle relative to the first bends 11. In the back frame member 10B in the Second Embodiment, the second bends 12 are located at about 1/12 of the whole length of the back frame member 10B from the ends of the back frame member 10B.

In the back frame member 10B in the Second Embodiment, each second bend 12 is formed by displacing an outward section of the back frame member 10B located laterally outward in the vehicle relative to the second bend 12 toward the vehicle front at a second angle β with respect to an intermediate section extending between the first and second bends 11 and 12 in the back frame member 10B. The second angle β is the angle formed by the intermediate section extending between the first and second bends 11 and 12 and the outward section located laterally outward in the vehicle relative to the second bend 12. The second angle β may be about the same as the first angle α at the first bend 11 (e.g., 175° to 179°) and preferably the same as the first angle α. As shown in FIG. 8, each end section of the back frame member 10B is thus positioned more toward the inside of the frame (i.e. toward the vehicle front) with respect to the direction in which the back frame member 10B extends between the first and second bends 11 and 12, as it goes from the second bend laterally outward in the vehicle relative to the second bend 12.

As shown in FIGS. 6 to 8, the battery mounting frame 1 in the Second Embodiment comprises a hollow frame with the front frame member 10F, the back frame member 10B, and the two side frame members 20 and is disposed so as to enclose the battery B. Accordingly, when subjected to an impact load F in the event of a side collision of the vehicle, the battery mounting frame 1 in the Second Embodiment is deformed under the impact load F in a similar way to the First Embodiment, thereby protecting the battery B placed inside the battery mounting frame 1.

### Comparison of Battery Mounting Frame of Second Embodiment with Conventional Example and First Embodiment

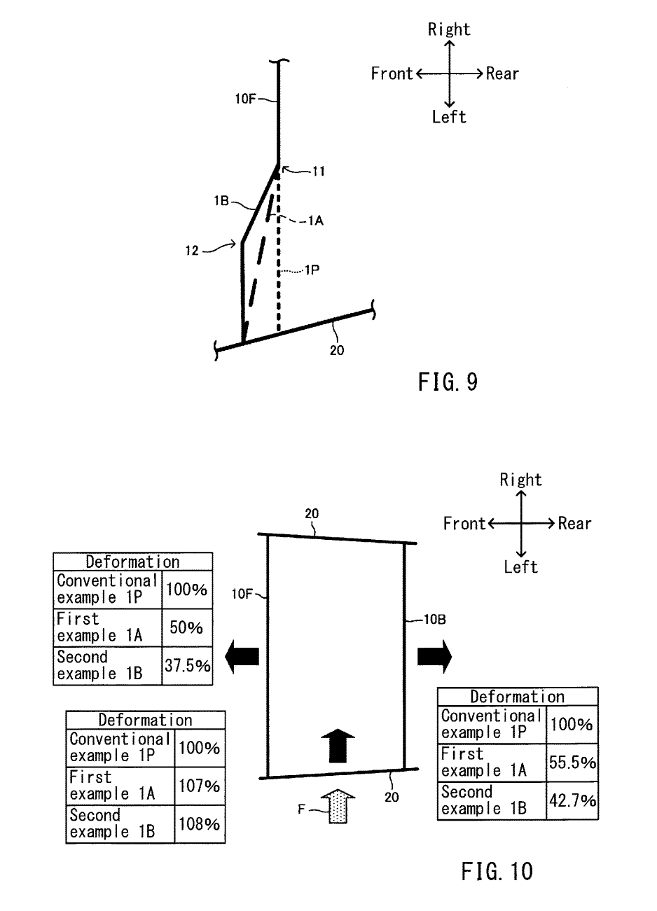

The battery mounting frame 1 in Second Embodiment will be compared with the battery mounting frame 1 in First Embodiment and the conventional example with reference to FIGS. 9 and 10 with regard to the amount of deformation that is caused by an impact load F in the event of a side collision of the vehicle. In the following description, Second Example 1B refers to the battery mounting frame 1 in Second Embodiment. As in First Embodiment, First Example 1A refers to the battery mounting frame 1 in First Embodiment, and Conventional Example 1P refers to the conventional battery mounting frame.

As shown in FIG. 9, in Second Example 1B (second embodiment), the front and back frame members 10F and 10B are disposed such that their laterally middle sections are disposed in the same positions as the laterally middle sections of the front and back frame members 10F and 10B in Conventional Example 1P and First Example 1A. The ends of the front and back frame members 10F and 10B in Second Example 1B are joined to each side frame member 20 in the same positional relationship as that of the front and back frame members 10F and 10B in First Example 1A.

Next, comparison among the battery mounting frames 1 (Conventional Example 1P, First Example 1A, and Second Example 1B) configured as described above will be described with reference to FIG. 10 with regard to the amount by which each frame member is deformed when subjected to an impact load F due to a side collision on the left side of the vehicle. In the following description, as in First Embodiment, the amount of deformation of each frame member in Conventional Example 1P is regarded as 100% in the comparison with the amounts of deformation of each frame member in First Example 1A and Second Example 1B.

As shown in FIG. 10, in the case where an impact load F is applied from the left side of the vehicle to the battery mounting frame 1 of Second Example 1B, the side frame member 20 is displaced toward the inside of the frame by the impact load F. In this case, the amount of deformation of the side frame member 20 in Second Example 1B is 108% relative to Conventional Example 1P that is 100%. This means an 8% increase relative to Conventional Example 1P. Since the amount of deformation of the side frame member 20 in First Example 1A is 107%, there is no significant difference in amount of deformation of the side frame member 20 between Second Example 1B and First Example 1A.

If the increase in amount of deformation of the side frame member 20 in Second Example 1B is as small as about 8%, then the side frame member 20 will not contact the battery B placed inside the battery mounting frame 1, in a similar manner to the First Example 1A, so that the battery B is protected by the battery mounting frame 1.

In the case where the impact load F is applied from the left side of the vehicle to the battery mounting frame 1, the front frame member 10F of the battery mounting frame 1 is compressed between the side frame members 20 on both sides by the impact loads F. Since the front frame member 10F in Second Example 1B has the first bends 11 and the second bends 12, the impact load F serves more to facilitate bending of the front frame member 10F at the first bends 11 and the second bends 12 than to deform the front frame member 10F toward the vehicle front. This reduces the amount of deformation of the front frame member 10F toward the vehicle front.

As can also be seen from the analysis results shown in FIG. 10, the amount of deformation of the front frame member 10F in Second Example 1B is 37.5% relative to Conventional Example 1P that is 100%. This means a 62.5% decrease relative to Conventional Example 1P. Since the amount of deformation of the front frame member 10F in First Example 1A is 50%, the amount of deformation of the front frame member 10F in Second Example 1B is decreased as compared to First Example 1A as well.

That is, the amount by which the front frame member 10F is deformed by an impact load F that is applied in the event of a side collision can be reduced by forming the first bends 11 and the second bends 12 in the front frame member 10F of the battery mounting frame 1. Therefore, the battery mounting frame 1 of Second Example 1B (Second Embodiment) reduces the possibility that the front frame member 10F may be deformed toward the vehicle front so much as to contact any of the surrounding components P in the event of a side collision, and thereby prevents damage to the surrounding components P.

In the case where the impact load F is applied from the left side of the vehicle, the back frame member 10B of the battery mounting frame 1 is compressed between the side frame members 20 on both sides by the impact loads F. Since the back frame member 10B in Second Example 1B also has the first bends 11 and the second bends 12, the impact load F serves more to facilitate bending of the back frame member 10B at the first bends 11 and the second bends 12 than to deform the back frame member 10B toward the vehicle rear. This reduces the amount of deformation of the back frame member 10B toward the vehicle rear.

The amount of deformation of the back frame member 10B in Second Example 1B is about 42.7% relative to Conventional Example 1P that is 100%. This means about a 57.3% decrease relative to Conventional Example 1P (see FIG. 10). Since the amount of deformation of the back frame member 10B in First Example 1A is about 55.5%, the amount of deformation of the back frame member 10B in Second Example 1B is decreased as compared to First Example 1A as well.

In the same way as in the front frame member 10F described above, the first bends 11 and the second bends 12 in the back frame member 10B of the battery mounting frame 1 reduce the deformation of the back frame member 10B caused by an impact load F in the event of a side collision. Therefore, the battery mounting frame 1 of Second Example 1B (Second Embodiment) reduces the possibility that the back frame member 10B may be deformed toward the vehicle rear so much as to contact any of the surrounding components P in the event of a side collision, and thereby prevents damage to the surrounding components P.

As described above, as in First Embodiment, the battery mounting frame 1 in Second Embodiment is formed as a hollow frame having the front frame member 10F, the back frame member 10B, and the two side frame members 20 and having a trapezoidal shape as viewed in plan and is disposed such that the battery B is located inside the frame (see FIG. 7). As shown in FIG. 10, the battery mounting frame 1 can thus bear the impact load F that is applied in the event of a side collision of the vehicle, and thereby prevent the battery B placed inside the frame from the impact load F.

In the battery mounting frame 1 in Second Embodiment, as in First Embodiment, the front frame member 10F has the first bends 11 and is bent at the first angle α at the first bends 11, so that the front frame member 10F is positioned more toward the vehicle front as it goes from the first bend 11 laterally outward in the vehicle. As in First Embodiment, the back frame member 10B also has the first bends 11 and is bent at the first angle α at the first bends 11, so that the back frame member 10B is positioned more toward the vehicle rear as it goes from the first bend 11 laterally outward in the vehicle.

Moreover, the front frame member 10F in Second Embodiment has the second bends 12 located laterally outward in the vehicle relative to the first bends 11 and is bent at the second angle β at the second bends 12, so that the front frame member 10F is positioned more toward the inside of the frame (i.e. toward the vehicle rear) with respect to the direction in which the front frame member 10F extends between the first and second bends 11 and 12, as it goes from the second bend 12 laterally outward in the vehicle with respect to the second bends 12. The back frame member 10B also has the second bends 12 located laterally outward in the vehicle relative to the first bends 11 and is bent at the second angle ft at the second bends 12, so that the back frame member 10B is positioned more toward the inside of the frame (i.e. toward the vehicle front) with respect to the direction in which the back frame member 10B extends between the first and second bends 11 and 12, as it goes from the first bend 12 laterally outward in the vehicle relative to the second bends 12.

As shown in FIG. 10, the battery mounting frame 1 of Second Embodiment includes the first bends 11 and the second bends 12 in the lateral end portions of the front and back frame members 10F and 10B. This can reduce the amounts by which the front and back frame members 10F and 10B are deformed when subjected to an impact load F in the event of a side collision of the vehicle to about 40% of Conventional Example 1P. The battery mounting frame 1 thus reduces contact of the battery mounting frame 1 with the battery B and the surrounding components P, thereby preventing damage to the surrounding components P. The battery mounting frame 1 can improve the capability of preventing damage to the surrounding components P by merely including the second bends 12 in addition to the first bends 11 in the front and back frame members 10F and 10B. This allows for producing a high performance battery mounting frame 1 without substantial cost increase.

As shown in FIG. 6, in Second Embodiment, the front frame member 10F, the back frame member 10B, and the two side frame members 20 each comprise a rectangular steel tube. The battery mounting frame 1 is formed by welding the front and back frame members 10F and 10B to each side frame member 20 with the end faces of the front and back frame members 10F and 10B butted with the side surface of each side frame member 20. The Second Embodiment allows for low cost production of the simply configured battery mounting frame 1 that can more effectively protect the battery B from side collisions while prevent damage to the surrounding components P.

While the present invention has been described above by way of embodiments, the present invention is not limited in any way to the above embodiments, and various improvements and modifications are possible without departing from the spirit and scope of the present invention. For example, the front frame member 10F, the back frame member 10B, and the side frame members 20 each have been described in the above embodiments as being formed by a rectangular steel tube. However, the present invention is not limited to this embodiment. The front frame member 10F, the back frame member 10B, and the side frame members 20 may each comprise a steel tube having other shape in section (e.g., a round steel tube) or may be made of a steel material such as lip channel steel or channel steel.

The battery mounting frame 1 has been described in an embodiment above as having a trapezoidal shape as viewed in plan due to the arrangement of the surrounding components P. However, the present invention is not limited to this embodiment. The battery mounting frame 1 may at least be a hollow frame including the front frame member 10F, the back frame member 10B, and the two side frame members 20, and the front frame member 10F, the back frame member 10B. The battery mounting frame 1 may have a rectangular shape as viewed in plan.

The front and back frame members 10F and 10B have been described in an embodiment above as being sufficiently longer than the side frame members 20. However, the present invention is not limited to this embodiment. For example, the front and back frame members 10F and 10B may have the same length as, or may be slightly longer than, the side frame members 20. In the case where the front frame member 10F, the back frame member 10B, and the side frame members 20 have substantially the same length, the present invention can have its effects even if the side frame members 20 are made slightly longer.

The first angle α defined by the first bends 11 in the front frame member 10F may be the same as or different from the first angle α defined by the first bends 11 in the back frame member 10B. In one of the first frame members (the front frame member 10F or the back frame member 10B), the first angle α defined by the first bends 11 may be the same as the second angle β defined by the second bends 12, or the first angle α may be different from the second angle β.

In assembly of the battery mounting frame 1, the front and back frame members 10F and 10B have been described in embodiments above as being welded to each side frame member 20 with the end faces of the front and back frame members 10F and 10B being butted with the side surface of each side frame member 20. However, the present invention is not limited to this embodiment. The ends of the front frame member 10F, the back frame member 10B, and the side frame members 20 may be cut at an angle, and the resultant end faces of the front frame member 10F, the back frame member 10B, and the side frame members 20 may be brought into contact with each other and welded together. The method for joining the frame members is not limited to welding. Various processes can be employed as long as they can join the front frame member 10F, the back frame member 10B, and the side frame members 20 together with desired strength or more.

### DESCRIPTION OF THE REFERENCE NUMERALS

1 Battery mounting frame
10F Front Frame Member
10B Back Frame Member
11 First Bend
12 Second Bend
20 Side Frame Member
B Battery
P Surrounding Component
F Impact load
α First Angle
β Second Angle

1. A battery mounting frame for mounting a battery on a vehicle, comprising a hollow frame having:
a pair of first frame members positioned in the vehicle on front and rear sides of the battery mounted on the vehicle, the first frame members extending in a lateral direction of the vehicle; and
a pair of second frame members positioned in the vehicle on laterally outward sides of the battery, the second frame members connecting ends of the first frame members, wherein the battery mounting frame is supported on a vehicle body such that the battery is located inside the frame,
wherein each first frame member has a length equal to or larger than that of each second frame member, and
wherein each first frame member has, in each lateral end portion, a first bend of a first angle such that the first frame member is positioned more toward the outside of the frame as the member goes from the first bend laterally outward in the vehicle.

2. The battery mounting frame according to claim 1,
wherein each first frame member has a second bend of a second angle at a location that is laterally outward in the vehicle relative to each first bend, and
wherein each second bend in the first frame member is such that the first frame member is positioned more toward the inside of the frame, with respect to a direction in which the first frame member extends between the first and second bends, as the member goes from the second bend laterally outward in the vehicle.

3. The battery mounting frame according to claim 1,
wherein the first frame members and the second frame members each comprise a steel tube, and
wherein the battery mounting frame is formed by joining the ends of the first frame members and ends of the second frame members.
